(19) United States
(12) Patent Application Publication
(10) Pub. No.: US 2024/0123916 A1
(43) Pub. Date: Apr. 18, 2024

(54) Magnetic Tailgate Pad for Bikes

(71) Applicant: Tribe Creations LLC, Thousand Oaks, CA (US)

(72) Inventor: Chris Daniel Petrula, Thousand Oaks, CA (US)

(21) Appl. No.: 18/485,917

(22) Filed: Oct. 12, 2023

Related U.S. Application Data
(60) Provisional application No. 63/379,169, filed on Oct. 12, 2022.

(51) Int. Cl. B60R 13/01

(52) U.S. Cl. CPC B60R 13/01

(57) ABSTRACT

A tailgate pad designed to be hung over the tailgate a pickup trucking allowing bikes to be hung without scratching the paint or denting the tailgate of the truck. The tailgate pad has an outer shell, an inner pad, and a plurality of magnets. These magnets are able to stay in place by way of magnetic force with having a first and second endplate. The inner pad has a plurality of apertures cut through the pad, allowing the magnets to be threaded through with the endplates of the magnet lying flush with the inner pad. These magnets are what keep the tailgate pad in place when on the vehicle.

### FIELD OF THE INVENTION

The present invention relates generally to tailgate pads for a truck. More specifically a portable tailgate pad to allow for the transportation of bikes.

### BACKGROUND OF THE INVENTION

Pickup trucks are common vehicles used to transport items. The bed of a pickup truck provides the driver with a large bed to haul oversized items that may not fit inside of the vehicle, such as a bike. When the driver makes a turn, if the bike isn't secured the bike will slide about the truck bed. One way users often position the bike to prevent it from moving, is to hang the front wheel of the bike over the tailgate while keeping the rear of the bike inside the truck bed. A risk of this, however, is that the paint of the vehicle can get scratched up from the bike resting on the tailgate. To prevent damage, tailgate pads are used to provide a barrier between the bike and the surface of the vehicle. However, often times tailgate pads come with lengthy straps that a user must thread through the hinge of the tailgate after the pad is placed on the truck. These straps are long, require multiple straps to secure the tailgate pad, and the pad often needs repositioning as the pad shifts while the straps are tightened. Securing these straps can be a lengthy tiring process.

An object of the present invention to provide a pad that is quick and easy to install. The present invention is a flexible pad that is designed to be placed over the tailgate. The pad is held in place by use of multiple magnets which secure the pad in place upon the magnet coming in contact with the metal of the vehicle. The pad has an outer shell made of waterproof material and an inner panel made of a flexible foam. The pad can be placed on the vehicle, is secured upon the magnets contacting the vehicle, and can be installed in mere second.

### BRIEF DESCRIPTION OF THE DRAWINGS

FIG. 1 is a perspective view of the present invention.

FIG. 2 is a top front perspective view of the inner panel of the present invention.

FIG. 3 is a top perspective view of inner panel of the present invention.

FIG. 4 is a left view of the present invention.

FIG. 5 is a right view of the present invention.

FIG. 6 is a front perspective view of the magnets of the present invention.

FIG. 7 is a top front perspective view of the magnets of the present invention.

FIG. 8 is a perspective view of the inner pad with the magnets in place.

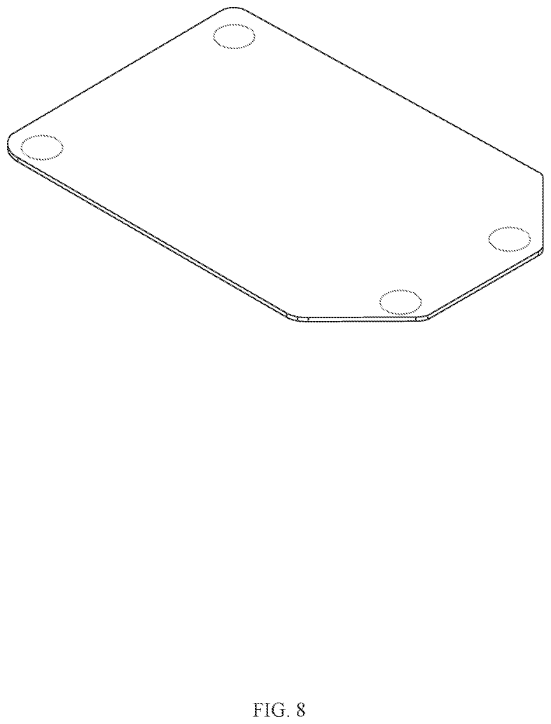

FIG. 9 is a top front perspective view of the invention.

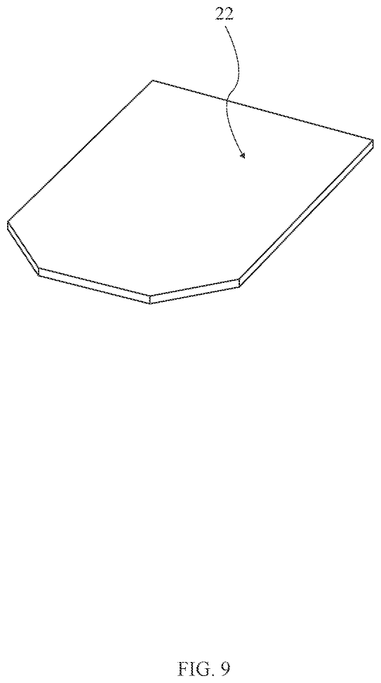

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances and should not be considered to be limiting to the scope of the present invention as a whole.

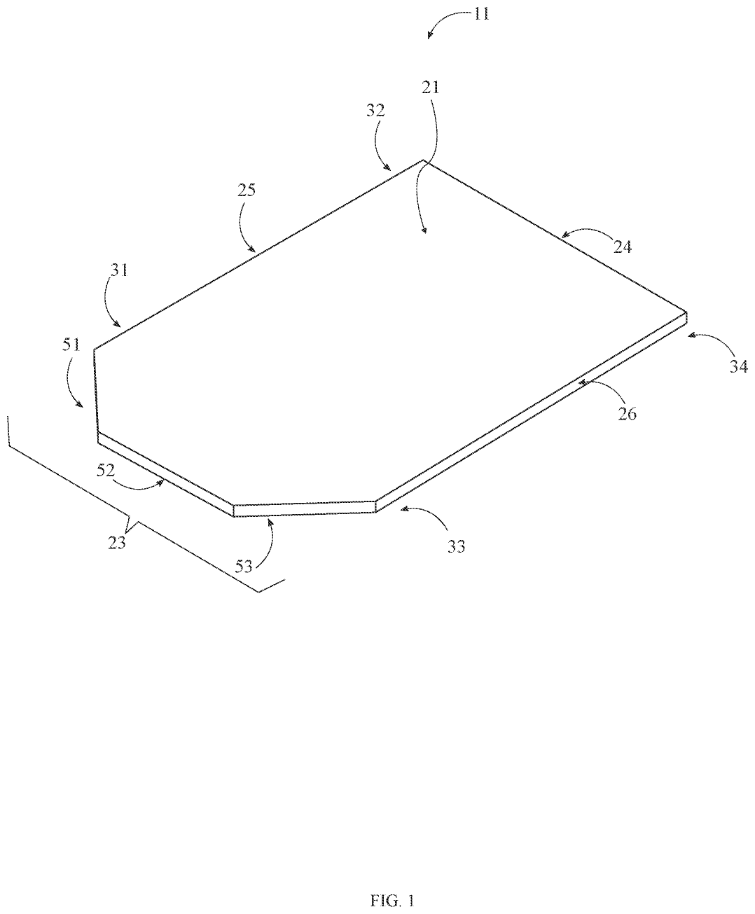

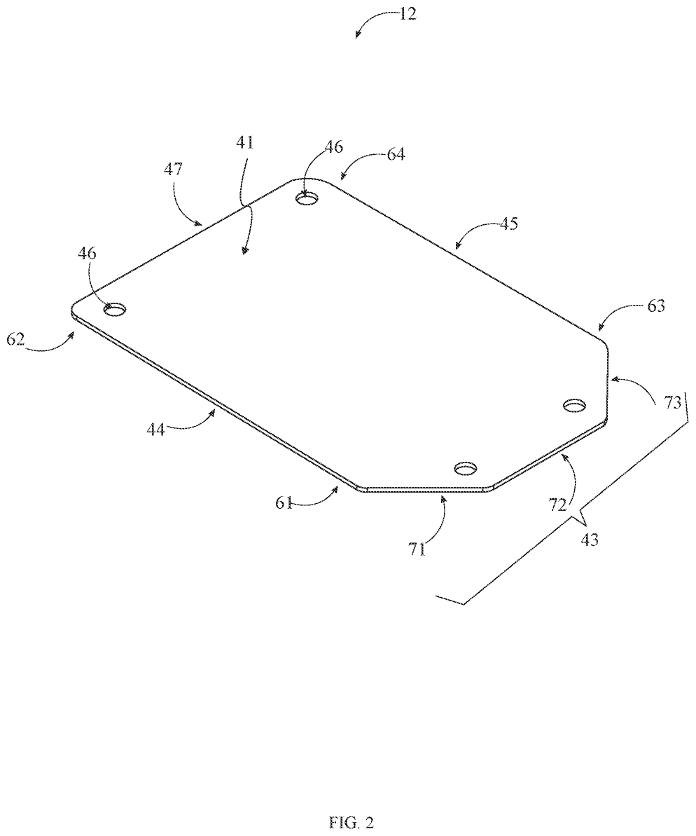

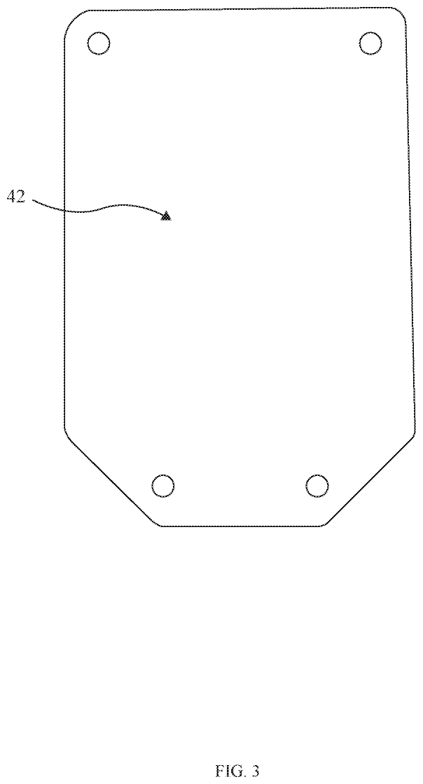

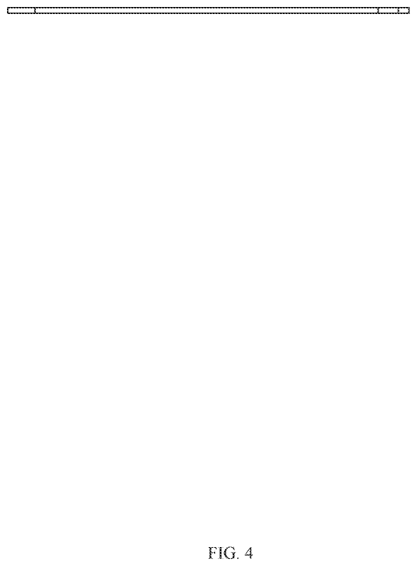

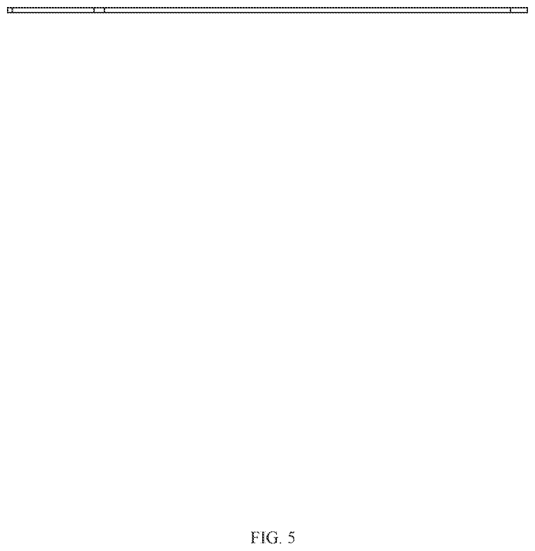

As shown in FIGS. 1-7, the present invention is a pad that is equipped with magnets to secure itself to the tailgate of a pick-up truck. An object of the present invention is to provide a protective barrier between the truck and a bicycle or any other object that may be hung over the tailgate. This is necessary so as to not have bikes or any other equipment that is hung from tailgate to scratch the paint of the vehicle or to dent it. To accomplish this, the present invention is a flat panel made of flexible material allowing it to bend to be placed over the tailgate of a pick-up truck. The pad is comprised of an outer shell 11, an inner panel 12, and a plurality of magnets 13.

The outer shell 11 is made of durable waterproof nylon or any material that will protect against water, rain, stones, or any other elements that could potentially be damaging to the pad or to the vehicle the pad is hung on. The pad is reversible and can be made in any color.

The outer shell 11 comprises a top panel 21 and a bottom panel 22. The outer shell 11 is further comprised of a front side 23, a rear side 24, a left side 25, and a right side 26. The left side 25 and right side 26 run parallel to one another. The front side 23 comprises a first edge 51, a second edge 52, and a third edge 53. The left side 25 has an anterior end 31 and a posterior end 32 and the right side 26 has an anterior end 33 and a posterior end 34.

The rear side 24 is positioned between the posterior end 34 of the right side 26 and the posterior end 32 of the left side 25. When the rear side 24 connects with the posterior end 33 of the right side 26 and the posterior end 32 of the left side 25, a 90 degree angle is formed at both corners.

The first edge 51 is angularly offset from the anterior end 31 of the left side 25. The third edge 53 is angularly offset from the anterior end 33 of the right side 26. The second edge 52 of the front side 23 is positioned between the first edge 51 and third edge 53. The second edge 52 is positioned in between the first edge 51 and the third edge 53 opposite the anterior end of the left side 25 and opposite the anterior end of the right side of the outer shell 11.

The inner panel 12 is made of a polyethylene foam pad. The inner panel 12 is of similar shape but is of a smaller size than the outer shell 11 allowing it to be fully enclosed within the outer shell 11. The inner panel 12 comprises, a first side 43, a second side 44, a third side 45, and a fourth side 47. The inner panel 12 further comprises a top side 41 and a bottom side 42. The second side 44 and third side 45 run parallel to one another. The second side 44 has a forward end 61 and a rearward end 62. Additionally, the third side 45 has a forward end 63 and a rearward end 64. The first side 43 comprising a first brim 71, a second brim 72, and a third brim 73. The fourth side 47 being positioned between the rearward end 62 of the second side 44 and the rearward end 64 of the third side 45. The first brim 71 is angularly offset from the forward end 61 of the second side 44. The third brim 73 is angularly offset from the forward end 63 of the third side 45. The second brim 72 is positioned between the first brim 71 and the third brim 73. The second brim 72 connects to the first brim 71 opposite the forward end 61 of the second side 44. The second brim 72 connects to the third brim 73 opposite the forward end 63 of the third side 45. The inner panel 12 further comprises a plurality of apertures 46. Each of the plurality of apertures 46 traverses the panel from the top side of the inner panel 12 to the bottom side 42 of the inner panel 12.

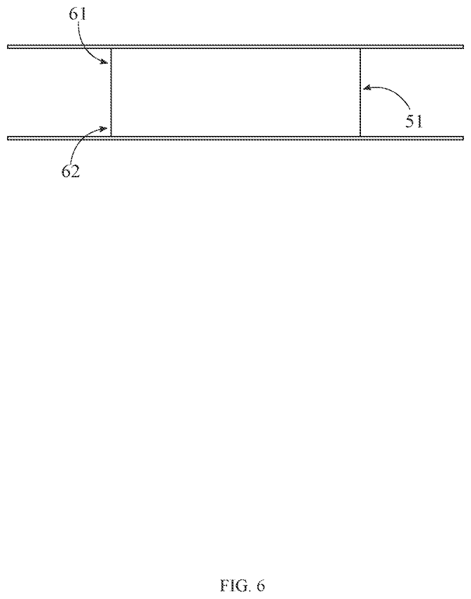

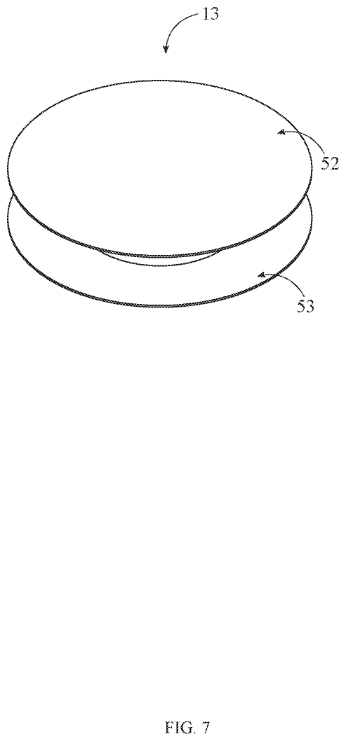

As shown in FIGS. 6 and 7, the present invention comprises a plurality of magnets 13. By way of magnetic force, the magnets hold the tailgate pad in place when mounted to the tailgate of a pickup truck. Each of the plurality of magnets 13 has a first supporting face 52 and a second supporting face 53. Each of the plurality of magnets 13 has a support shaft 51 connecting the first supporting face 52 and the second supporting face 53. The support shaft 51 has a upper end 61 and a lower end 62. The first supporting face 52 is centrally positioned the top end of the support shaft 51. The second supporting face 53 is centrally positioned on the bottom end of the of the support shaft 51. Each of the plurality of magnets 13 traverse through the plurality of apertures 46 in the inner panel 12. The diameter of the first supporting face 52 and second supporting face 53 is larger than the diameter of the support shaft 51 which is slightly smaller than the diameter of each of the plurality of magnets 13. This allows for the first supporting face 52 and the second supporting face 53 to rest in tandem with the inner panel 12 and not fall out.

Although the invention has been explained in relation to its preferred embodiment, it is to be understood that many other possible modifications and variations can be made without departing from the spirit and scope of the invention.

What is claimed is:

1. A tailgate pad comprising:
an outer shell;
an inner panel;
a plurality of magnets;
each of the plurality of magnets comprising a support shaft, a first supporting face, and a second supporting face;
the outer shell further comprising a front side, a rear side, a left side and a right side;
the left and right side being parallel to one another; and
the front side comprising a first edge, a second edge, and a third edge.

2. The tailgate pad as in claim 1 further comprising:
the outer shell comprising a top panel and a bottom panel.

3. The tailgate pad as in claim 1 further comprising:
the left side has an anterior end and a posterior end;
the right side has an anterior end and a posterior end; and
the rear side being positioned between the posterior end of the right side and the posterior end of the left side.

4. The tailgate pad as in claim 3 further comprising:
the first edge is angularly offset from the anterior end of the left side;
the third edge is angularly offset from the anterior end of the right side
the second edge is positioned between the first edge and third edge;
the second edge connects to the first edge opposite the anterior end of the left side; and
the second edge connects to the third edge opposite the anterior end of the right side.

5. The tailgate pad as in claim 1 further comprising:
the inner panel comprises a first side, a second side, a third side, and a fourth side;
the inner panel further comprises a top side and a bottom side; and
the inner pad being smaller in size than the outer shell.

6. The tailgate pad as in claim 5 further comprising:
the second side has a forward end and a rearward end;
the third side has a forward end and a rearward end; and
the fourth side being positioned between the rearward end of the second side and the rearward end of the third side; and
the first side comprising a first brim, a second brim, and a third brim.

7. The tailgate pad as in claim 6 further comprising:
the first brim is angularly offset from the anterior end of the second side;
the third brim is angularly offset from the anterior end of the third side
the second brim is positioned between the first brim and the third brim;
the second brim connects to the first brim opposite the anterior end of the second side; and
the second brim connects to the third brim opposite the anterior end of the third side.

8. The tailgate pad as in claim 1 further comprising:
the inner panel having a plurality of apertures; and
each of the plurality of apertures traversing from the top side of the panel to the bottom side of the panel.

9. The tailgate pad as in claim 1 further comprising:
the support shaft has an upper end and a lower end;
the first supporting face is centrally positioned on the upper end of the support shaft;
the second supporting face is centrally positioned on the lower end of the support shaft;
each of the plurality of magnets traverse through the plurality of apertures; and
the first supporting face and the second supporting face being larger in diameter than the support shaft.

10. A tailgate pad comprising:
an outer shell;
an inner panel;
a plurality of magnets;
each of the plurality of magnets comprising a support shaft, a first supporting face, and a second supporting face;
the outer shell further comprising a front side, a rear side, a left side and a right side;
the left and right side being parallel to one another;
the front side comprising a first edge, a second edge, and a third edge;
the outer shell comprising a top panel and a bottom panel;
the first edge is angularly offset from the anterior end of the left side; and
the third edge is angularly offset from the anterior end of the right side.

11. The tailgate pad as in claim 10 further comprising:
the left side has an anterior end and a posterior end;
the right side has an anterior end and a posterior end;
the rear side being positioned between the posterior end of the right side and the posterior end of the left side;
the second edge is positioned between the first edge and third edge;
the second edge connects to the first edge opposite the anterior end of the left side; and
the second edge connects to the third edge opposite the anterior end of the right side.

12. The tailgate pad as in claim 10 further comprising:
the inner panel comprises a first side, a second side, a third side, and a fourth side;
the inner panel further comprises a top side and a bottom side;
the inner panel being smaller in size than the outer shell;
the second side has a forward end and a rearward end; and
the third side has a forward end and a rearward end.

13. The tailgate pad as in claim 10 further comprising:
the first side comprising a first brim, a second brim, and a third brim;
the first brim is angularly offset from the forward end of the second side;
the third brim is angularly offset from the forward end of the third side the second brim is positioned between the first brim and the third brim;
the second brim connects to the first brim opposite the forward end of the second side;
the second brim connects to the third brim opposite the forward end of the third side; and
the fourth side being positioned between the rearward end of the second side and the rearward end of the third side.

14. The tailgate pad as in claim 10 further comprising:
the inner panel having a plurality of apertures.

15. The tailgate pad as in claim 14 further comprising:
each of the plurality of apertures traversing from the top side of the inner panel to the bottom side of the inner panel;
the support shaft has an upper end and a lower end;
the first supporting face is centrally positioned on the upper end of the support shaft;
the second supporting face is centrally positioned on the lower end of the support shaft;
each of the plurality of magnets traverse through the plurality of apertures; and
the first supporting face and the second supporting face being larger in diameter than the support shaft.

16. A tailgate pad comprising:
an outer shell;
an inner panel;
a plurality of magnets;
the inner panel being smaller in size than the outer shell;
each of the plurality of magnets comprising a support shaft, a first supporting face, and a second supporting face;
the outer shell further comprising a front side, a rear side, a left side and a right side;
the left and right side being parallel to one another;
the front side comprising a first edge, a second edge, and a third edge;
the outer shell comprising a top panel and a bottom panel;
the first edge is angularly offset from the anterior end of the left side; and
the third edge is angularly offset from the anterior end of the right side.

17. The tailgate pad as in claim 16 further comprising:
the left side has an anterior end and a posterior end;
the right side has an anterior end and a posterior end;
the rear side being positioned between the posterior end of the right side and the posterior end of the left side;
the second edge is positioned between the first edge and third edge;
the second edge connects to the first edge opposite the anterior end of the left side;
the second edge connects to the third edge opposite the anterior end of the right side;
the inner panel comprises a first side, a second side, a third side, and a fourth side; and
the inner panel further comprises a top side and a bottom side.

18. The tailgate pad as in claim 17 further comprising:
the second side has a forward end and a rearward end;
the third side has a forward end and a rearward end;
the first side comprising a first brim, a second brim, and a third brim;
the first brim is angularly offset from the anterior end of the second side;
the third brim is angularly offset from the anterior end of the third side the second brim is positioned between the first brim and the third brim;
the second brim connects to the first brim opposite the anterior end of the second side;
the second brim connects to the third brim opposite the anterior end of the third side; and
the fourth side being positioned between the rearward end of the second side and the rearward end of the third side.

19. The tailgate pad as in claim 16 further comprising:
the inner panel having a plurality of apertures;
each of the plurality of apertures traversing from the top side of the panel to the bottom side of the panel;
the support shaft has an upper end and a lower end;
the first supporting face is centrally positioned on the upper end of the support shaft;
the second supporting face is centrally positioned on the lower end of the support shaft;
each of the plurality of magnets traverse through the plurality of apertures; and
the first supporting face and the second supporting face being larger in diameter than the support shaft.
